(19) United States
(12) Patent Application Publication
(10) Pub. No.: US 2014/0375806 A1
(43) Pub. Date: Dec. 25, 2014

(54) CONFIGURABLE DISPLAY SYSTEM

(71) Applicant: Caterpillar Inc., Peoria, IL (US)

(72) Inventor: Jacob C. Maley, Germantown Hills, IL (US)

(21) Appl. No.: 13/924,655

(22) Filed: Jun. 24, 2013

(51) Int. Cl. B60R 1/00

(52) U.S. Cl. CPC B60R 1/00
USPC 348/148

(57) ABSTRACT

A system for assisting an operator to maneuver a machine is provided. The system includes an image capturing device configured to capture an image of an environment in relation to the machine. The system also includes a display device configured to display an overlay of a plurality of zones on the captured image, the zones have one or more associated parameters. A controller is communicably coupled to the display device. The controller is configured to receive a user input indicative of a change associated with the one or more parameters associated with at least one of the plurality of zones. The controller is also configured to adjust the one or more parameters of at least one of the plurality of zones based on the user input. Further, the controller is configured to display the adjusted overlay on the display device.

### TECHNICAL FIELD

The present disclosure relates to a display system for a machine, and more specifically to a system and method for assisting an operator to maneuver the machine on a site.

### BACKGROUND

Operators of large machines can utilize vehicle display devices to assist in properly positioning the machine. Automobiles for instance can use backup cameras and corresponding displays

For example, U.S. Pat. Nos. 7,623,681 and 7,561,720 relate to a system for determining range and lateral position of a vehicle.

### SUMMARY OF THE DISCLOSURE

In one aspect of the present disclosure, a system for assisting an operator to maneuver a machine is provided. The system includes an image capturing device configured to capture an image of an environment in relation to the machine. The system also includes a display device configured to display an overlay of a plurality of zones onto a captured image, the plurality of zones have one or more associated parameters. A controller is communicably coupled to the display device. The controller is configured to receive a user input indicative of a change associated with the one or more parameters of the at least one of the plurality of zones. The controller is also configured to adjust the one or more parameters associated with at least one of the plurality of zones based on the user input. Further, the controller is configured to transmit the adjusted overlay on the display device.

In another aspect, a method for assisting an operator to maneuver a machine is provided. The method includes receiving a captured image of an environment in relation to the machine. The method includes displaying an overlay of a plurality of zones onto the captured image, the plurality of zones has one or more associated parameters. The method receives a user input indicative of a change associated with the one or more parameters of at least one of the plurality of zones. Further, the method adjusts the overlay of the plurality of zones based on the user input.

Other features and aspects of this disclosure will be apparent from the following description and the accompanying drawings.

### BRIEF DESCRIPTION OF THE DRAWINGS

FIG. 1 is an exemplary machine, according to one embodiment of the present disclosure;

FIG. 2 is a block diagram of an operator assistance system;

FIGS. 3, 4 and 5 are exemplary displays provided by the operator assistance system; and

FIG. 6 is a flowchart of a method for assisting an operator to maneuver the machine shown in FIG. 1.

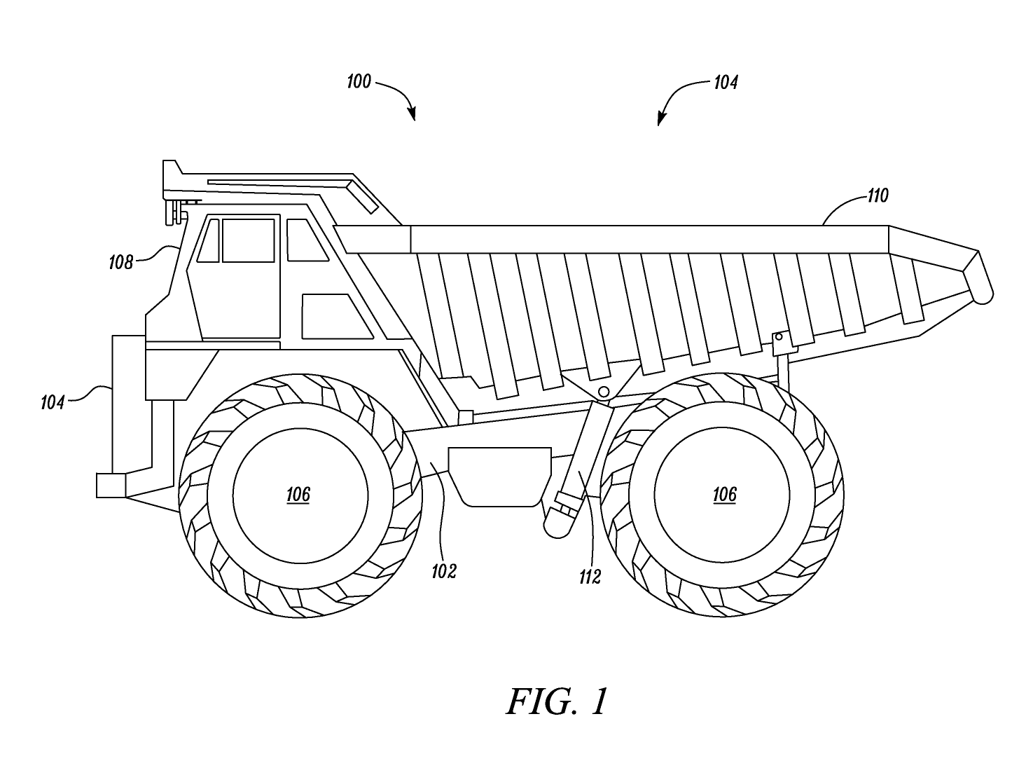

### DETAILED DESCRIPTION

Wherever possible, the same reference numbers will be used throughout the drawings to refer to the same or the like parts. FIG. 1 illustrates an exemplary machine 100, according to one embodiment of the present disclosure. More specifically, the machine 100 may be a large mining truck. It should be noted that the machine 100 may include any other industrial machine including, but not limited to, a large mining truck, an articulated truck, an off-highway truck and the like. In another embodiment, the machine 100 may be one of various types of machinery used in a number of industries such as mining, agriculture, construction, forestry, waste management, and material handling among others.

Referring to FIG. 1, the machine 100 may include a frame and/or a chassis 102. A powertrain (not shown) may be provided on the machine 100 which may include one or more power sources. An enclosure 104 may be provided on the chassis 102 of the machine 100 which may house the power source (not shown). The power source may be any one or a combination of an internal combustion engine, a gas turbine, a hybrid engine, a non-conventional power source like batteries, electric motor, or any other power source known in the art. The powertrain may further include a transmission inclusive of gearing, drive shafts, propeller shaft and other known drive links provided for transmission of motive power from the power source to a set of ground engaging members 106. The ground engaging members 106, such as wheels or tracks, may be provided to the machine 100 for the purpose of mobility. An operator cabin 108 may be provided on the machine 100 which may house various controls of the machine 100.

As shown in FIG. 1, a truck body 110 may be fixedly or pivotally mounted on the chassis 102 of the machine 100. Hydraulic and/or pneumatic cylinders 112 may be mounted on the chassis 102 and connected to the truck body 110 to enable movement in the form of tilting of the truck body 110 with respect to the chassis 102 of the machine 100. The machine 100 may be operative on a worksite.

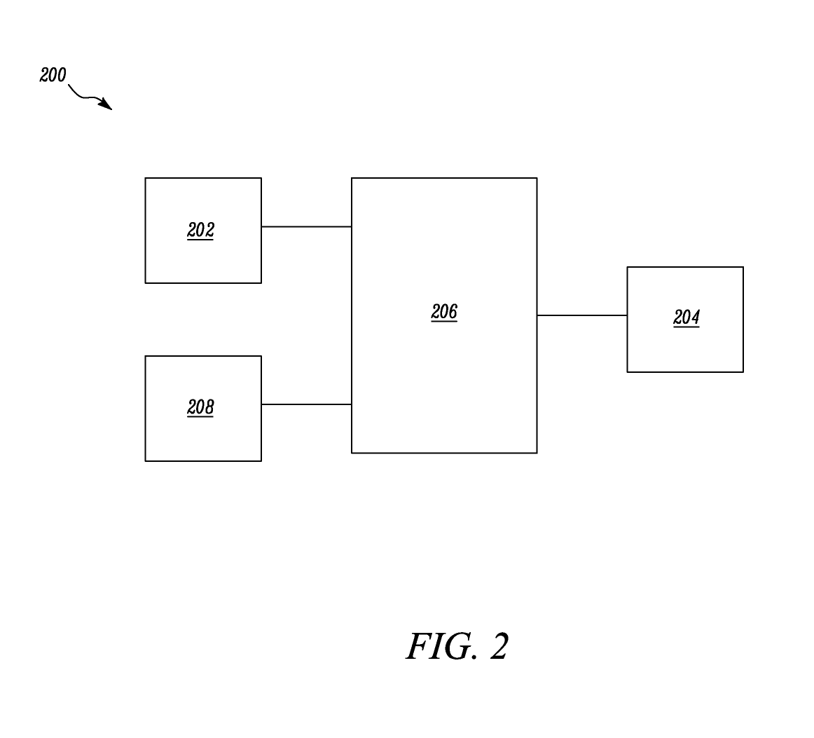

Referring to FIG. 2, the machine 100 may include an image capturing device 202, such as, for example, a rear view camera, a bird's eye view camera, a front view camera, a side camera and so on. The image capturing device 202 may be configured to capture an image of an environment in relation to the machine 100. For example, in case of the rear view camera, the image capturing device 202 may capture an area surrounding a rear portion of the machine 100. The image capturing device 202 may be present on-board the machine 100. Alternatively, the image capturing device 202 may be present off-board the machine 100. Accordingly, based on the location of the image capturing device 202, the presence of the machine 100 may be optionally included in the image captured by the image capturing device 202. In one embodiment, the image may include a simulated view generated by a suitable simulation device.

Further, a display device 204 may be communicably coupled to the image capturing device 202. The display device 204 may be configured to display the image captured by the image capturing device 202. The display device 204 may be a monitor, a screen, a touchscreen or any other display device known in the art. The display device 204 may be located in the operator cabin 108 of the machine 100. In an exemplary case, when the machine 100 is controlled from the remote location, the display device 204 may be present off-board the machine 100, at the remote location.

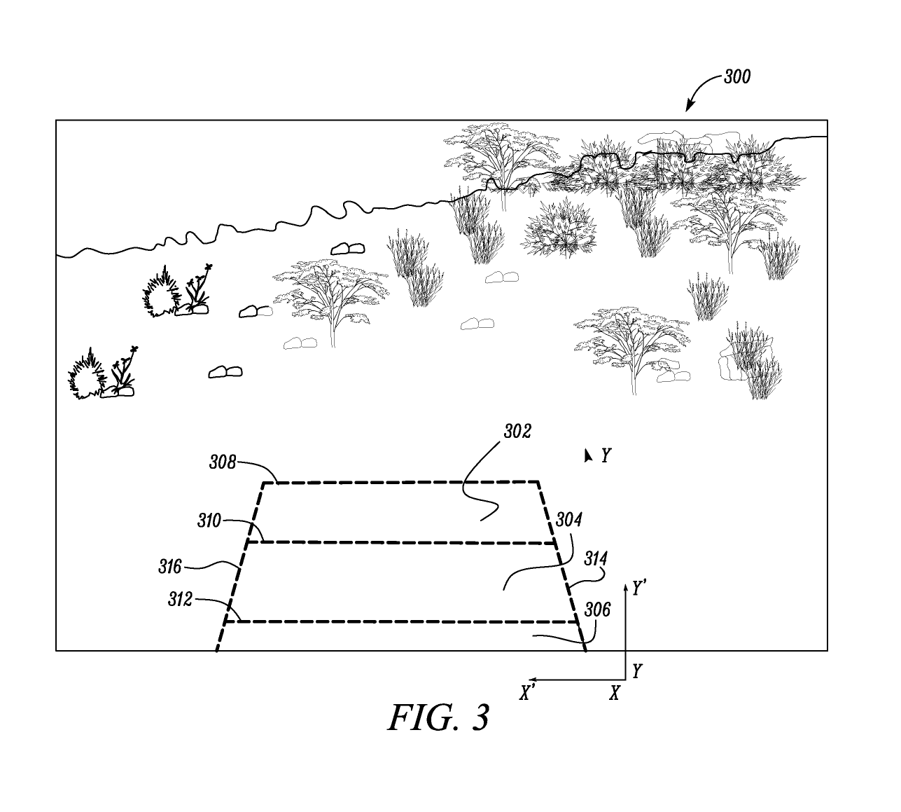

During travel of the machine 100 on the worksite, in order to assist an operator of the machine 100 to properly position the machine 100 relative to other machines, objects or obstacles present on the worksite, a plurality of zones 302, 304, 306 (shown in FIGS. 3, 4 and 5) or guidance lanes may be overlaid on the captured image. The present disclosure relates to a controller 206 configured to adjust the plurality of zones 302, 304, 306 displayed on the display device 204 based on a user input.

FIG. 2 illustrates a block diagram of an operator assistance system 200. The controller 206 may be communicably coupled to the image capturing device 202. The controller 206 may be configured to receive the image captured by the image capturing device 202. As described earlier, the controller 206 is configured to overlay or superimpose the plurality of zones 302, 304, 306 on the captured image.

Referring to FIG. 3, each of the zones 302, 304, 306 may have a substantially trapezoidal configuration. Moreover, each of the zones 302, 304, 306 may be arranged adjacent to each other. The zones 302, 304, 306 may be formed using continuous or dashed lines 308, 310, 312, 314, 316. Also, either a single color may be used to represent the zones 302, 304, 306, or the zones 302, 304, 306 may be multi-colored. Similarly, the zones 302, 304, 306 may have configurable brightness and transparency. In one exemplary situation, three zones 302, 304, 306 are overlaid on the captured image. One of ordinary skill in the art will appreciate that the visual representation of the zones 302, 304, 306 such as depth, width, color, brightness, transparency, number and so on may vary based on the application. The visual representation may be selected either automatically by the controller 206 based on the application or may be configured based on the inputs as provided by the operator of the machine 100. The captured image including the overlay of the plurality of zones 302, 304, 306 may be displayed on the display device 204.

As mentioned earlier, the controller 206 may be configured to adjust the plurality of zones 302, 304, 306 based on the user input. Accordingly, in one embodiment, the controller 206 may be coupled to a user input device 208. In one embodiment, the user input device 208 may also serve as the display device 204. For example, in a situation in which the display device 204 is a touchscreen, the display device 204 may be capable of receiving the user input in the form of touch gestures. In another embodiment, the user input device 208 may be a control panel or a joystick. In case of the control panel, the user input may be provided by pressing buttons or keys provided on the control panel. In case of the joystick, different positions of the joystick may correspond to various user inputs. The user input device 208 may be configured to generate a signal indicative of the user input related to one or parameters associated with the at least one of the plurality of zones 302, 304, 306.

The one or more parameters may include the depth and/or the width of zones 302, 304, 306. More specifically, the user input may be indicative of the adjustment in the depth and/or the width in any of the zones 302, 304, 306. This adjustment may either be an increase or a decrease in the depth and/or the width in any of the zones 302, 304, 306. Accordingly, the controller 206 may be configured to perform the adjustment based on the user input. In one embodiment, the controller 206 may be configured to automatically adjust the other zones in cooperation with the adjustment made for the given zone.

Also, in one embodiment, the controller 206 may receive an input from the operator associated with an appearance of at least one of the plurality of zones 302, 304, 306. The term “appearance” used herein refers to a way in which the overlay appears to the operator. The appearance may include at least one of a color, brightness and transparency of the desired zone 302, 304, 306. Based on the input received, the appearance of any of the plurality of zones 302, 304, 306 may be changed by the controller 206. For example, the operator may provide the input to the controller 206 indicating that the color of the zone 302 should be changed from red to yellow. The controller 206 may accordingly change the color of the zone 302 to yellow. A person of ordinary skill in the art will appreciate that the input may be provided by any known means such as, for example, buttons, keys, control panels and so on.

In another embodiment, the controller 206 may allow the operator to add or remove zones 302, 304, 306 associated with the overlay. The user input provided by the operator to the controller 206 may include dimensions and location of the zone to be added to or removed from the overlay. It should be noted that the addition or the removal of the zones may be done in such a manner so as to allow a seamless integration with the existent overlay. For example, during the removal of a said zone, the other zones may be appropriately adjusted.

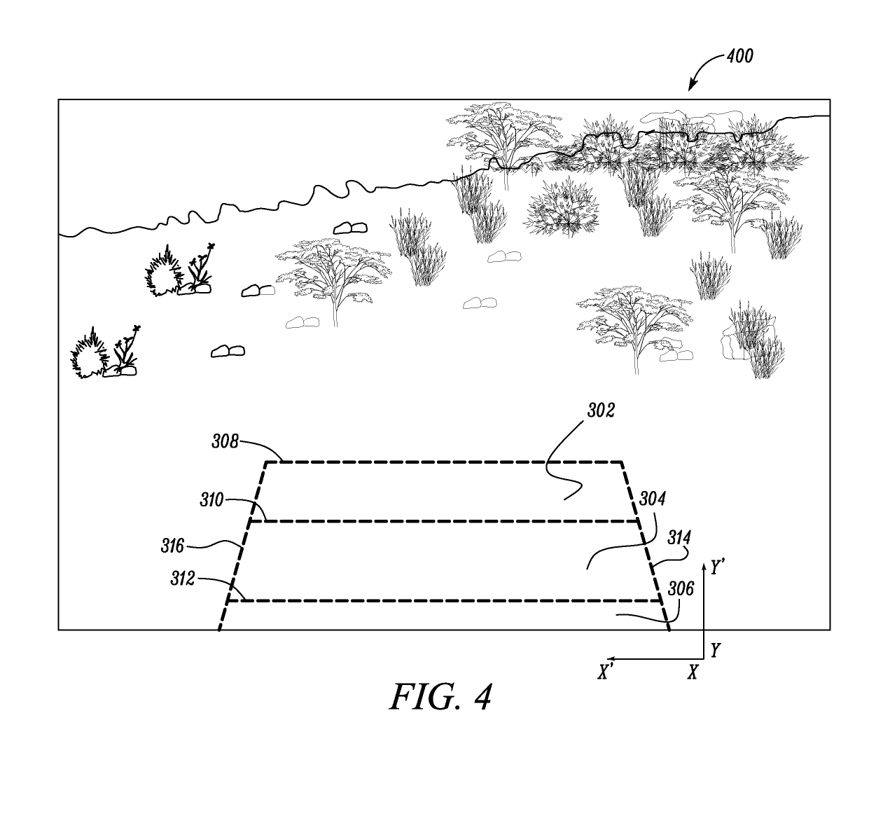

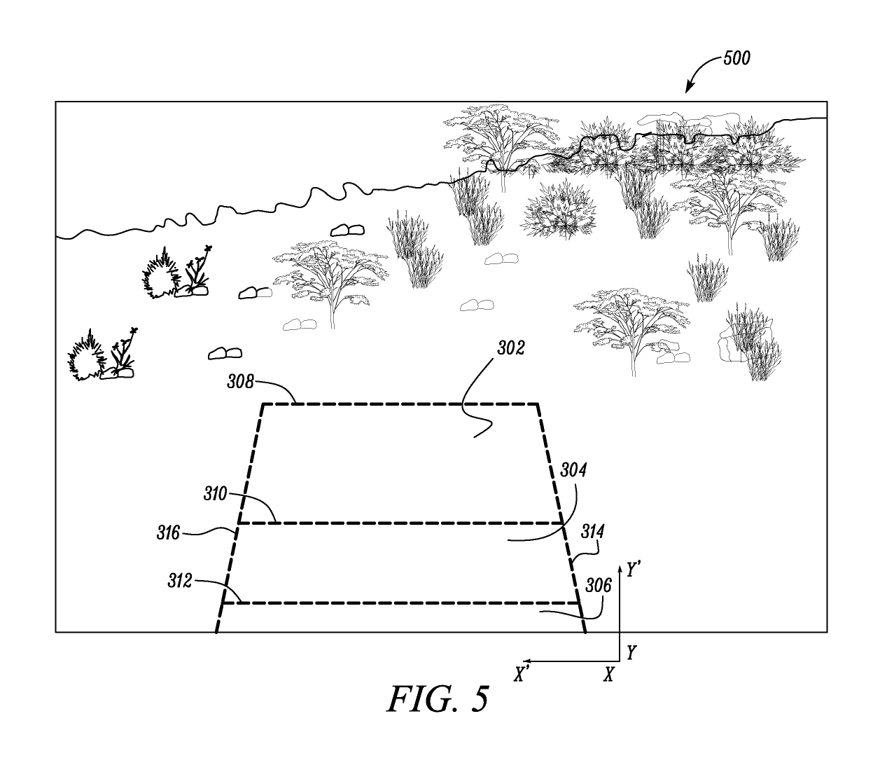

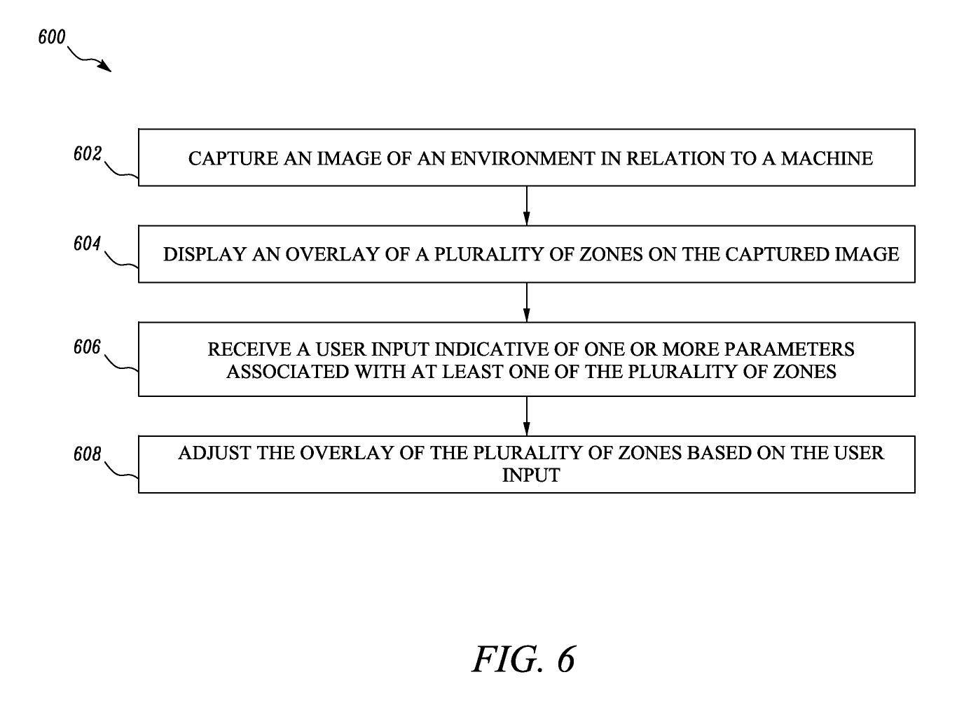

Further, the controller 206 may be configured to transmit the adjusted plurality of zones 302, 304, 306 on the display device 204. Referring to FIG. 3, the display 300 may be displayed on the touchscreen. FIGS. 4 and 5 illustrate two different exemplary displays 400 and 500, which are displayed to the operator based on width and depth adjustments made to the zone 302 shown in display 300 respectively.

As described earlier, the operator may configure the display 300 as per his requirements. In one exemplary situation, the operator may attempt to increase the width of the line 308. In order to do so, the operator may first select the line 308 using up and down arrow keys. Thereafter, the operator may increase the width of the line 308 using suitable keys. In this case, the operator has attempted to increase the width of the zone 302 rightwards.

The controller 206 may be configured to adjust the overlay based on the user input provided by the operator. The controller 206 may correspondingly adjust the other zones 304, 306 in cooperation with the adjusted zone 302. Accordingly, in this case, the controller 206 may proportionally increase the width of the other zones 304, 306 based on the increase in the width of the zone 302. The display 400 illustrates the adjusted overlay, which is displayed on the display device 204. In one embodiment, the controller 206 may be configured to adjust the left hand side of the zone 302 symmetrical to the increase made by the operator on the right hand side of zone 302.

In another case, the operator may attempt to increase the depth of the zone 302 shown in FIG. 3. Accordingly, the operator may touch the line 316 associated with the zone 302 and may drag and drop the line 316, thereby extending the length of the line 316 in a direction away from that of the machine 100. Based on the adjustment made to the line 316, the controller 206 may adjust the lines 308, 314. The adjusted display 500 may accordingly be displayed on the display device 204.

In various embodiments of the invention, the controller 206 may be configured to change a centre point location of the adjusted zones 302, 304, 306 based on the user input. For example, the user may provide an input indicative of change required with the location of zone 302 along the direction XX′ and/or along the direction YY′. In one embodiment, the overlay feature may be turned off or on by the operator. In another embodiment, the overlay feature may be automatically turned off or on by the controller.

A person of ordinary skill in the art will appreciate that the displays and the adjustments shown in the accompanying figures are merely on an illustrative basis and do not limit the scope of the present disclosure. The controller 206 may embody a single microprocessor or multiple microprocessors that includes a means for receiving the captured image. Numerous commercially available microprocessors may be configured to perform the functions of the controller 206. It should be appreciated that the controller 206 may readily embody a general machine microprocessor capable of controlling numerous machine functions. A person of ordinary skill in the art will appreciate that the controller 206 may additionally include other components and may also perform other functionality not described herein.

### INDUSTRIAL APPLICABILITY

Known display systems provided for large machines allow for multiple zones overlay on images captured by the rear camera. These displays may be modified based on a steering distraction of the machine.

The present disclosure relates to the operator assistance system 200 which allows the plurality of zones 302, 304, 306 to be adjusted based on the user input. Moreover, the overlay of the plurality of zones 302, 304, 306 may also assist the operator while backing up the machine 100 relative to any other machine or object in close proximity Also, the overlay may represent the plurality of zones 302, 304, 306 defined by a mine site template. In one exemplary case, the template may include three zones 302, 304, 306 having approximate depths of 2 m, 6 m and 10 m respectively. The disclosure may also be utilized for forward facing configurations in which more than one reference is required in order to maneuver the machine 100 to a specific location.

At step 602, the controller 206 receives the captured image of the environment in relation to the machine 100. At step 604, the overlay of the plurality of zones 302, 304, 306 may be displayed on the captured image and further the captured image is transmitted to the display device 204 for displaying to an operator of the machine 100. The plurality of zones 302, 304, 306 may have one or more associated parameters. At step 606, the controller 206 receives the user input indicative of changes associated with the one or more parameters of at least one of the plurality of zones 302, 304, 306.

As described above, the user input may be associated with the width and/or depth of at least one of the plurality of zones 302, 304, 306. At step 608, the controller 206 adjusts the one or more parameters of at least one of the plurality of zones 302, 304, 306 based on the user input. In one embodiment, the controller 206 receives the input associated with the appearance of at least one of the zones 302, 304, 306. The controller 206 changes the appearance of the desired zone 302, 304, 306 based on the received input. In another embodiment, the controller may add or remove zones 302, 304, 306 associated with the overlay based on the user input.

It should be noted that although the description provided herein is provided in connection with display systems provided on large machines, the disclosure may be utilized for any display application in which two objects may interact with each other at relative positions.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A system for assisting an operator to maneuver a machine, the system comprising:
an image capturing device configured to capture an image of an environment in relation to the machine;
a display device configured to display a captured image and display an overlay of a plurality of zones onto the captured image, wherein the plurality of zones includes one or more associated parameters; and
a controller communicably coupled to the display device, the controller configured to:
receive a user input indicative of a change associated with the one or more parameters of at least one of the plurality of zones;
adjust the one or more parameters associated with at least one of the plurality of zones based on the user input; and
transmit the adjusted overlay to the display device.

2. The system of claim 1, wherein the image capturing device includes any one of a rear view camera, a bird's eye view camera, a front camera and a side camera.

3. The system of claim 1, wherein the one or more parameters includes a depth of the zone.

4. The system of claim 1, wherein the one or more parameters includes a width of the zone.

5. The system of claim 1, wherein the display device includes a touch screen.

6. The system of claim 1, wherein the display device is located on board the machine.

7. The system of claim 1, wherein the display device is located at a location outside of the machine.

8. The system of claim 1, wherein each of the plurality of zones are arranged adjacent to each other.

9. The system of claim 1, wherein the controller is further configured to change a centre point location of the adjusted overlay of the plurality of zones on the display device.

10. The system of claim 1, wherein the controller is further configured to add or remove at least one of the plurality of zones to the overlay.

11. The system of claim 1, wherein the controller is further configured to:
receive an input indicative of an appearance of at least one of the plurality of zones; and
change the appearance of at least one of the plurality of zones based on the received input.

12. The system of claim 11, wherein the appearance includes at least one of a color, brightness and transparency of the zone.

13. A method for assisting an operator to maneuver a machine, the method comprising:
receiving a captured image of an environment in relation to the machine;
transmitting an overlay of a plurality of zones onto the captured image to a display device, wherein the plurality of zones includes one or more associated parameters;
receiving a user input indicative of a change associated with the one or more parameters of at least one of the plurality of zones; and
adjusting the one or more parameters associated with at least one of the plurality of zones based on the user input.

14. The method of claim 13, wherein the one or more parameters includes a depth of the zone.

15. The method of claim 13 further comprising adding or removing at least one of the plurality of zones to the overlay.

16. The method of claim 13 further comprising:
receiving an input indicative of an appearance of at least one of the plurality of zones; and
changing the appearance of at least one of the plurality of zones based on the received input.

17. The method of claim 16, wherein the appearance includes at least one of a color, brightness and transparency of the zone.

18. The method of claim 13 further comprises changing a centre point location of the adjusted overlay of the plurality of zones on the display device.

19. A system for assisting an operator to maneuver a machine, the system comprising:
a rear view camera configured to capture an image of an environment in relation to the machine;
a display device configured to display a captured image and display an overlay of a plurality of zones onto the captured image, wherein the plurality of zones having a depth and a width; and
a controller communicably coupled to the display device, the controller configured to:
receive a user input indicative of a change associated with the at least one of the depth and the width of at least one of the plurality of zones;
adjust the at least one of the depth and the width of the at least one of the plurality of zones based on the user input; and
transmit the adjusted overlay to the display device.

20. The system of claim 19, wherein the controller is further configured to:
receive an input indicative of an appearance of at least one of the plurality of zones; and
change the appearance of at least one of the plurality of zones based on the received input.
